(19) United States
(12) Patent Application Publication
(10) Pub. No.: US 2014/0065983 A1
(43) Pub. Date: Mar. 6, 2014

(54) COMMUNICATION TERMINAL WITH ANTENNA SWITCHING FUNCTION AND METHOD FOR AUTOMATICALLY SWITCHING BETWEEN ANTENNAS

(71) Applicant: HON HAI PRECISION INDUSTRY CO., LTD., New Taipei (TW)

(72) Inventor: LUNG-PAO CHEN, New Taipei (TW)

(73) Assignee: HON HAI PRECISION INDUSTRY CO., LTD., New Taipei (TW)

(21) Appl. No.: 13/674,908

(22) Filed: Nov. 12, 2012

(30) Foreign Application Priority Data
Sep. 3, 2012 (TW) 101131969

(51) Int. Cl. H04B 1/44

(52) U.S. Cl. CPC H04B 1/44
USPC 455/78

(57) ABSTRACT

A method for switching among antennas of a communication terminal includes receiving acceleration values periodically sensed by an accelerometer. The acceleration values indicate amount of changes in orientation of the communication terminal such as when a user changes from a standing up position to a laying down position. A difference value is calculated between a current acceleration value and a previous acceleration value. When the difference value is greater than a predetermined value, a switching unit is controlled to switch between a first antenna and a second differently oriented antenna, so that a best in use antenna orientation is maintained for best communication regardless of orientation of the communication terminal.

### BACKGROUND

1. Technical Field

The present disclosure relates to communication terminals with antenna switching function and methods for automatically switching between antennas, and particularly to a communication terminal with antenna switching function and a method for automatically switching between antennas using an accelerometer.

2. Description of Related Art

Many satellite communication terminals have a fixed orientation antenna with a predetermined direction, for receiving and sending electromagnetic waves. The orientation is set according to a presumed predominant orientation of the terminal when in use so that the antenna faces upward. However, the user may change positions such as from sitting to lying, thereby changing orientation of the terminal and that of the antenna, which can negatively impact effectiveness of the antenna.

Therefore, it is desirable to provide a communication terminal, which can overcome the above-mentioned shortcomings

### BRIEF DESCRIPTION OF THE DRAWINGS

FIG. 1 is a functional block diagram of a communication terminal with antenna switching function, according to a first embodiment.

FIG. 2 is a functional block diagram of a processing unit of the communication terminal of FIG. 1.

FIG. 3 is a flowchart showing a method for automatically switching between antennas by the communication terminal of FIG. 1.

### DETAILED DESCRIPTION

Embodiments of the disclosure will be described with reference to the accompanying drawings.

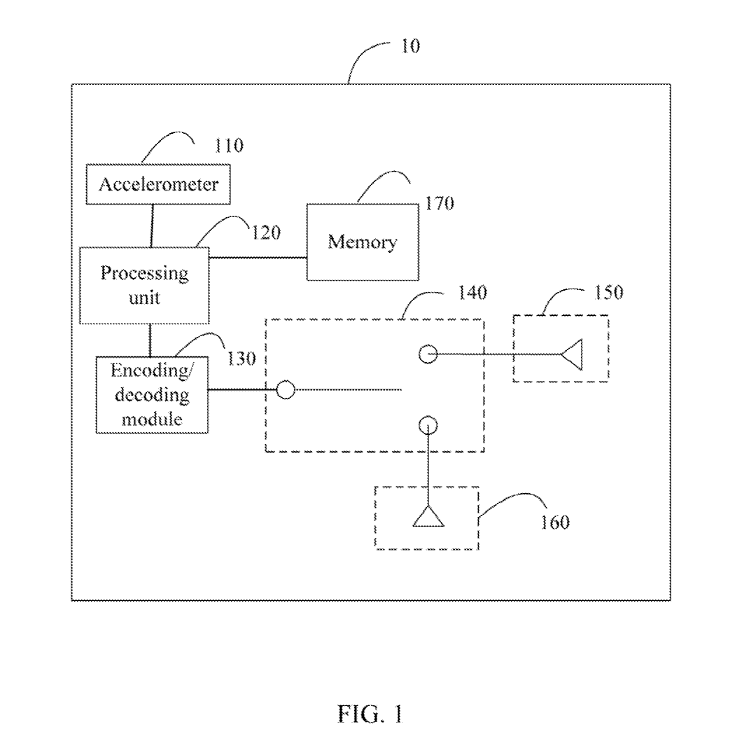

Referring to FIG. 1, a functional block diagram of a communication terminal with antenna switching function is provided. The communication terminal 10 is an electronic device, such as mobile phone, able to communicate with a satellite positioning system. The communication terminal 10 includes an accelerometer 110, a processing unit 120, a decoding/encoding unit 130, a switching unit 140, a first antenna 150, a second antenna 160, and a memory 170.

The accelerometer 110 periodically senses acceleration values of the communication terminal 10 and sends the acceleration values to the processing unit 120. Differences from one acceleration value to the next can indicate changes in orientation of the communication terminal 10.

The switching unit 140 is a double-throw switch, one end of which is connected with the encoding/decoding module 130, and another end of which is selectively connected with the first antenna 150 or the second antenna 160 to form a first path or a second path correspondingly for electromagnetic waves. The second antenna 160 is oriented perpendicular to the first antenna 150.

The memory 170 is used to store a predetermined value that is compared with difference values obtained from the acceleration values to determine when a large enough change in orientation of the communication terminal 10 warrants switching from the first antenna 150 to the second antenna 160.

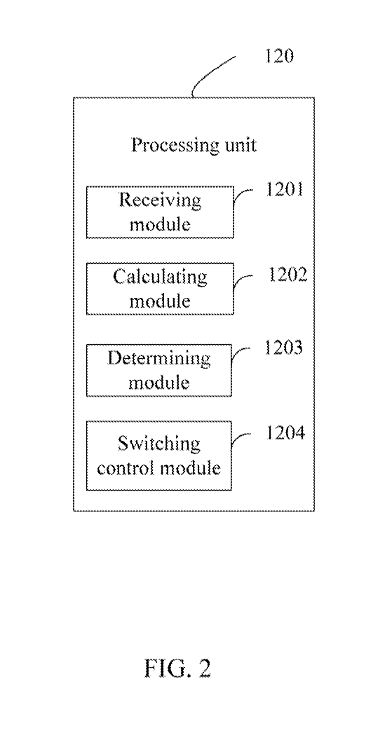

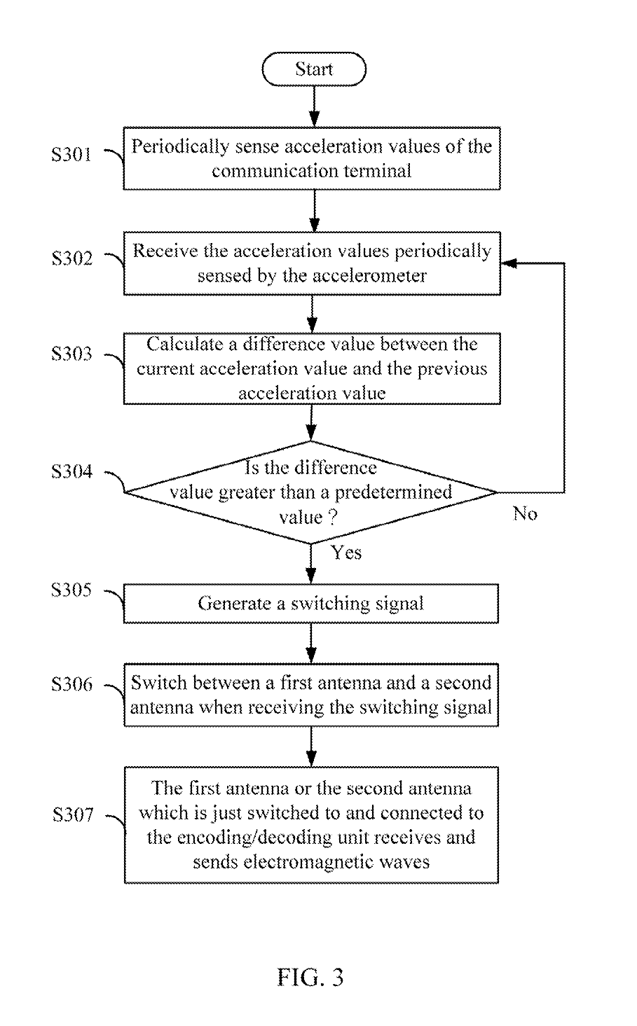

Together with FIG. 2, the processing unit 120 includes a receiving module 1201, a calculating module 1202, a determining module 1203, and a switching control module 1204. Functions of the modules will be described together with FIG. 3.

FIG. 3 is a flowchart showing a method for automatically switching between antennas by the communication terminal of FIG. 1.

In step S301, the accelerometer 110 periodically senses acceleration values of the communication terminal 10, and sends the acceleration values to the processing unit 120.

In step S302, the receiving module 1201 receives the acceleration values periodically sensed by the accelerometer 110.

In step S303, the calculating module 1203 calculates a difference value between the current acceleration value and the previous acceleration value.

In step S304, the determining module 1204 determines if the difference value is greater than the predetermined value stored in the memory 160. If yes, the procedure goes to step S305, if no, the procedure goes to step S302.

In step S305, the switching control module 1204 generates a switching signal to the switching unit 140 when the difference value is greater than the predetermined value stored in the memory 160.

In step S306, the switching unit 140 switches between the first path and the second path when receiving the switching signal. Typically, when the encoding/decoding unit 130 is connected to the first antenna 150, the switching unit 140 is switched to connect with the second antenna 160, and when the encoding/decoding unit 130 is connected to the second antenna 160, the switching unit 140 is switched to connect with the first antenna 150. Thereby, the switching unit 140 can be preset to connect the encoding/decoding unit 130 to the first antenna 150 or the second antenna 160.

In step S307, the first antenna 150 or the second antenna 160 which is just switched to and connected to the encoding/decoding unit 130 receives and sends electromagnetic waves.

Through the method above, when the user changes positions such as from sitting to lying, the communication terminal 10 can switch between the first antenna 150 and the second antenna 160, so as to change working antenna, thereby ensuring the antenna in use is facing upward.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A communication terminal with antenna switching function, comprising:
a processing unit;
an accelerometer, to periodically sense acceleration values of the communication terminal and sends the acceleration values to the processing unit;
a first antenna;
a second antenna, oriented perpendicular to the first antenna;
an encoding/decoding module;
a switching unit, one end is connected with the encoding/decoding module, another end is selectively connected with the first antenna or the second antenna to form a first path or a second path correspondingly for electromagnetic waves;
the processing unit further comprising:
a receiving module, to receive the acceleration values periodically sensed by the accelerometer;
a calculating module, to calculate a difference value between the current acceleration value and the previous acceleration value;
a determining module, to determine whether the difference value is greater than a predetermined value; and
a switching control module, to control the switching unit to switch between the first antenna and the second antenna, thus to switch between the first path and the second path when the difference value is greater than the predetermined value.

2. The communication terminal according to claim 1, wherein the switching unit is a double-throw switch.

3. The communication terminal according to claim 1, further comprising a memory to store the predetermined value.

4. The communication terminal according to claim 1, wherein when the encoding/decoding unit is connected to the first antenna and the difference value is greater than the predetermined value, the switching unit is switched to connect the second antenna, and when the encoding/decoding unit is connected to the second antenna and the difference value is greater than the predetermined value, the switching unit is switched to connect the first antenna.

5. The communication terminal according to claim 1, wherein the switching unit is preset to connect the encoding/decoding unit to the first antenna.

6. The communication terminal according to claim 1, wherein the switching unit is preset to connect the encoding/decoding unit to the second antenna.

7. The communication terminal according to claim 1, wherein the first antenna or the second antenna which is switched to and connected to the encoding/decoding unit receives and sends electromagnetic waves.

8. A method for automatically switching between antennas of a communication terminal, the communication terminal comprising an accelerometer, a first antenna, a second antenna oriented perpendicular to the first antenna, an encoding/decoding module, a switching unit, one end is connected with the encoding/decoding module, another end is selectively connected with the first antenna or the second antenna to form a first path or a second path correspondingly, the method comprising:
receiving acceleration values of the communication terminal periodically sensed by the accelerometer;
calculating a difference value between the current acceleration value and the previous acceleration value;
determining whether the difference value is greater than a predetermined value; and
controlling the switching unit to switch between the first antenna and the second antenna, thus to switch between the first path and the second path when the difference value is greater than the predetermined value.

9. The method according to claim 8, wherein the switching unit is a double-throw switch.

10. The method according to claim 8, wherein the communication terminal further comprises a memory to store the predetermined value.

11. The method according to claim 8, wherein, in the step of “controlling the switching unit to switch,” when the encoding/decoding unit is connected to the first antenna and the difference value is greater than the predetermined value, the switching unit is switched to connect the second antenna, and when the encoding/decoding unit is connected to the second antenna and the difference value is greater than the predetermined value, the switching unit is switched to connect the first antenna.

12. The method according to claim 8, wherein the switching unit is preset to connect the encoding/decoding unit to the first antenna.

13. The method according to claim 8, wherein the switching unit is preset to connect the encoding/decoding unit to the second antenna.

14. The method according to claim 8, further comprising: receiving and sending electromagnetic waves by the first antenna or the second antenna which is just switched to and connected to the encoding/decoding unit.
